(19) United States
(12) Patent Application Publication
(10) Pub. No.: US 2011/0053583 A1
(43) Pub. Date: Mar. 3, 2011

(54) User initiated virtual mobile management

(76) Inventors: Ramesh Parmar, Scotch Plains, NJ (US); Deepak Gonsalves, Union, NJ (US); Deepa Jagannatha, Somerset, NJ (US)

(21) Appl. No.: 12/550,742

(22) Filed: Aug. 31, 2009

(51) Int. Cl. H04M 3/00; H04W 4/00

(52) U.S. Cl. 455/419; 455/466

(57) ABSTRACT

Disclosed is a user initiated virtual mobile management process to improve support levels and enhance user experience. With this invention the user will have better control on the VMM as it allows the user to pause streaming when performing sensitive transactions. The user can directly make a connection with the help desk administrator for issue resolution that the user has on the mobile device. User can initiate the request through SMS, IVR, or Data Connection.

### FIELD OF INVENTION

The present invention relates to mobile wireless communication devices, systems, networks, and methods of operation. This invention describes remote management of the mobile devices when a user initiates the trouble ticket request. This invention also deals with the various modes for the user to request remote support.

### BACKGROUND OF INVENTION

Virtual Mobile Management (VMM) is a tool used by the Help Desk Administrators and other technicians to access user's Mobile Device for support purposes. When VMM is active the support personnel can do one of two things: 1) Observe activity on a user's Mobile Device or 2) Take control of a user's Mobile Device directly and perform a task or correct a problem. VMM is an extremely valuable support tool. The ability to observe activity on a user's mobile device allows support personnel to quickly pinpoint the source of a user's problem and provide proper instructions to the user. The ability to take control of a user's mobile device remotely allows support personnel to quickly resolve complex system problems without having the user to bring the device into a repair facility. This all enhances user experience and effectively reduces customer support duration.

Although VMM offers the opportunity to dramatically improve support levels and enhance user experience, it also brings up issues of privacy. With this invention the user will have better control on the VMM as it allows the user to pause streaming when performing sensitive transactions. The user can directly make a connection with the Help Desk administrator for resolution of any kind of issue that the user has on the mobile device.

### SUMMARY OF THE INVENTION

Disclosed is a user initiated virtual mobile management process for mobile telephone devices. The process includes the steps for establishing a connection mode between the mobile telephone device and a remotely positioned message router; queuing of a message received from the mobile telephone device through the message router; dispatching a queued message to a help desk administrator; initiating VMM session; determining a telecommand in response to the queued message and pushing said telecommand to said mobile telephone device; and executing the telecommand without user intervention.

An objective of the invention is to improve support levels in a user initiated virtual mobile management process.

Another objective of the invention is to enhance user experience in a user initiated virtual mobile management process.

Still another objective of the invention is to provide a user with better control on the VMM by allowing the user to pause streaming when performing sensitive transactions.

Another objective of the invention is to teach the use of a user initiated virtual mobile management process wherein the user can manage a mobile telephone device without a live session.

Another objective of the invention is to provide a virtual mobile management process wherein a telecommand can be used to obtain mobile telephony device information regarding processor, memory, data settings, e-mail settings and applications installed without any user intervention

Yet another objective of the invention is to provide the user with different connection modes to establish a VMM session wherein the connection mode is short message service (SMS), an interactive voice response (IVR), of an internet protocol for prompting the user to initiate a remote control session.

Another objective of the invention is to to perform a reset of e-mail settings, a reset of data settings, a phone reset, a backup of phone data, a backup of contacts, and roaming activation.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE DRAWINGS

FIG. 1 is the User Initiated Session—architecture.

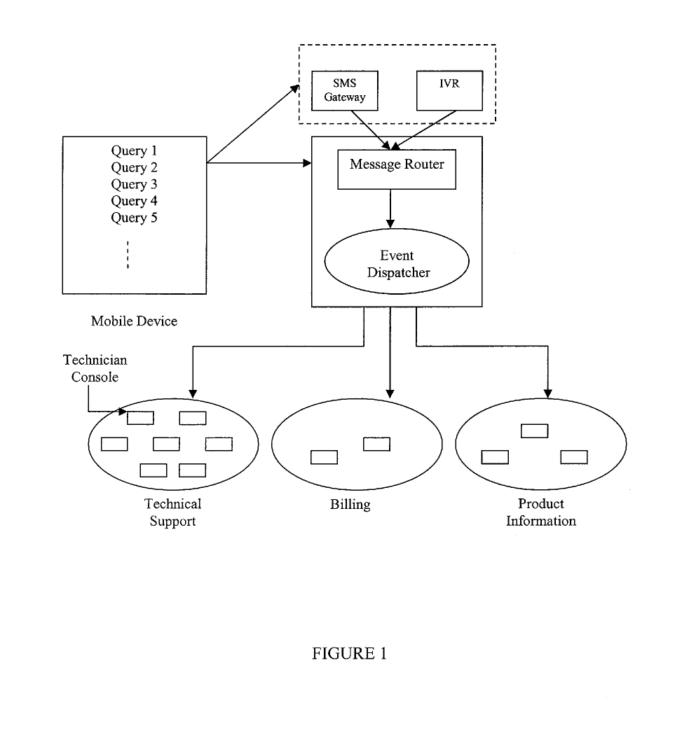

FIG. 2 is a flow diagram of the call flow.

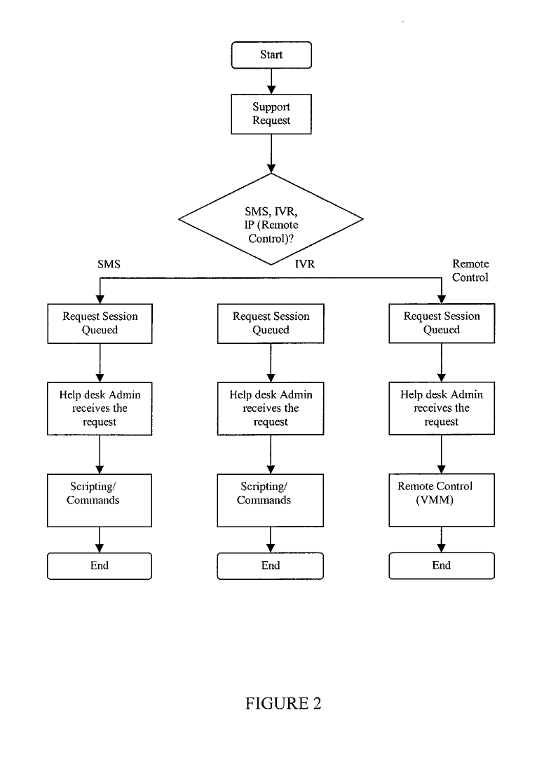

### DETAILED DESCRIPTION OF THE INVENTION

Although the invention will be described in terms of a specific embodiment, it will be readily apparent to those skilled in this art that various modifications, rearrangements and substitutions can be made without departing from the spirit of the invention. The scope of the invention is defined by the claims appended hereto

In the below model the client on the device will provide the user with all the options that are available to contact the Help Desk. Each Query (Support Request) will go to the Message Router. The Message Router will route the messages in the queue to the Event Dispatcher to process the user initiated request. The Event Dispatcher then dispatches the request to the appropriate group for troubleshooting.

The User can have different options for requesting Remote support from the Help Desk like Data Connectivity issues, Device Configuration issues, Account Details, Billing request etc.

The connection mode can be SMS (Short Message Service), IVR (Interactive Voice Response) or IP (Internet Protocol) Connection.

Every user initiated request can be routed to an appropriate group in the Help Desk.

The client residing on the device can provide different options for support requests.

Help desk administrator, based on the connection request type that is made by the user can decide whether it requires manual intervention or not.

If manual intervention is required then the Admin can choose to start a Remote Control session with the device or send telecommands to resolve the issues.

If manual intervention is not required then user can choose Interactive Voice Response (IVR) to select the type of support that is required.

User Initiated Session for Remote Control using IP Connection

Every User Initiated Query, which needs a Remote Control Session or a Live Customer Support Representative (CSR), will be queued in the Admin Server.

The Message Router will then route the message to the appropriate CSR with the help of the Event Dispatcher.

Every CSR will be notified that a user initiated session is in queue.

Any CSR who is ready to support the user in the queue will request for Remote Control and the session waiting status will be removed from the queue to notify the other CSRs that the session is being already attended.

The CSR can request from the device the following information using Scripts/Telecommands during a Remote Control Session (not limited to the ones mentioned below):

Processor Information

Memory Information

Data Settings

E-mail Settings

Applications Installed

User Initiated Session though IVR

Interactive Voice Response is a general term for mobile phone-based voice value-added services. By dialing a designated number, mobile phone users able to listen and choose the help options from the Help Desk without any manual intervention. The user calls the IVR system; the IVR system prompts the user to enter the Account Password. Once the User Account is verified the IVR prompts the user for all options that are available for remote support like (not limited to the ones mentioned below):

Reset E-mail Settings

Reset Data Settings

Reset Phone

Backup Phone Data

Backup Contacts

Activate Roaming

Each task is accomplished by pushing Scripts/Telecommands to the device which can execute remotely on the device without any user intervention. User Initiated Session through SMS

Short Message Service (SMS) is a communications protocol allowing the interchange of short text messages between mobile telephony devices. The user has to initiate a support request with the Help Desk through SMS.

The user can initiate a support request either for a Remote Control Session or request the Help Desk to do the following without having a live session

Reset E-mail Settings

Reset Data Settings

Reset Phone

Backup Phone Data

Backup Contacts

Activate Roaming

Each task is accomplished by pushing Scripts/Telecommands to the device which can execute remotely on the device without any user intervention.

### Session Queuing

Whenever a User initiates a session the session will be queued in the Message Router. The Message Router, based on the type of a session that has been requested, routes the message to the appropriate CSR Group through the Event Dispatcher.

Each CSR group will have set of technician consoles.

Every console will be notified immediately of a session waiting status

Any CSR who is ready to support the user who is in the queue will request for VMM and the session waiting status will be removed from the queue to notify the other CSRs that the session is being already attended.

### Survey

After every issue has been resolved the CSR can do a survey with the user as to how well the problem was resolved. Survey can be done by sending a Survey banner to the user to provide feedback. It is to be understood that while we have illustrated and described certain forms of my invention, it is not to be limited to the specific forms or arrangement of parts herein described and shown. It will be apparent to those skilled in the art that various changes may be made without departing from the scope of the invention and the invention is not to be considered limited to what is shown in the drawings and described in the specification.

1. A user initiated virtual mobile management process for mobile telephone devices comprising:
a device client with preformatted list of support request messages on a mobile telephone device;
establishing a connection mode between said mobile telephone device and a remotely positioned message router;
queuing of a message received from said mobile telephone device through said massage router;
dispatching a queued message to a help desk administrator;
initiating a VMM session;
determining a telecommand in response to the queued message and pushing said telecommand to said mobile telephone device;
executing said telecommand without user intervention.

2. The user initiated virtual mobile management process according to claim 1 wherein the user can manage a mobile telephone device without a live session.

3. The user initiated virtual mobile management process according to claim 1 wherein the user can pause streaming when performing sensitive transactions.

4. The user initiated virtual mobile management process according to claim 1 wherein said telecommand can be used to obtain mobile telephony device information regarding processor, memory, data settings, e-mail settings and applications installed.

5. The user initiated virtual mobile management process according to claim 1 wherein the connection mode is short message service (SMS), said connection mode allowing an interchange of text messages between mobile telephony devices to initiate a VMM session.

6. The user initiated virtual mobile management process according to claim 1 wherein the connection mode is an interactive voice response (IVR), said connection mode prompting the user to choose from a list of options to initiate a VMM session.

7. The user initiated virtual mobile management process according to claim 1 wherein the connection mode is an internet protocol, said connection mode prompting the user to choose from a list of options to initiate a VMM session.

8. The user initiated virtual mobile management process according to claim 1 wherein said remote control session can perform a reset of e-mail settings, a reset of data settings, a phone reset, a backup of phone data, a backup of contacts, and activate roaming.

9. The user initiated virtual mobile management process according to claim 1 wherein the connection mode is an internet protocol, said connection mode securing said user to a live customer support to initiate a VMM session.

10. The user initiated virtual mobile management process according to claim 1 wherein said help desk administrator routes said queued message to a group of live customer support representatives (CSR) notifying each CSR of a queued message waiting status, said queued message waiting status remove from the queue when a first CSR attends the message.
